(19) United States
(12) Patent Application Publication
(10) Pub. No.: US 2007/0001070 A1
(43) Pub. Date: Jan. 4, 2007

(54) Suspension device for paint removal devices, as well as for removal of varnish and putty, intended to be arranged near or in contact with a wall or another painted surface

(76) Inventor: Birger Ericson, Alingsas (SE)

Correspondence Address: YOUNG & THOMPSON, 745 SOUTH 23RD STREET, 2ND FLOOR, ARLINGTON, VA, 22202, US

(21) Appl. No.: 11/475,999

(22) Filed: Jun. 28, 2006

Related U.S. Application Data
(60) Provisional application No. 60/694,670, filed on Jun. 29, 2005.

(51) Int. Cl. F16M 11/04

(52) U.S. Cl. 248/176.3

(57) ABSTRACT

A suspension device for a paint, varnish or putty removal devices, is intended to be arranged near or in contact with a wall, a ceiling, a floor or the like, and adapted for treatment of old paint, putty or varnish on the surface of an object by means of heat radiation. The suspension device includes a horizontally pivotable arm which at one end portion is displaceably mounted and horizontally pivotally arranged on a bar. The other end portion of the arm supports one or several paint removal devices which are rotably connected to the arm. The arm includes at least a first and a second rigid section being horizontally pivotally connected to each other round a vertical axis.

### TECHNICAL FIELD

The present invention relates to a suspension device for paint removal devices which devices are intended to be arranged near or in contact with a wall, a ceiling, a floor, window frames and door frames, windows, doors, boats or a piece of furniture or the like, and which are adapted for treatment of old paint, varnish, putty or the like by means of a heating element, e.g. a heat radiator. It is required that such devices are movable along the surface which is to be treated and therefore, to this end, the devices must be suspended in a suitable manner.

### BACKGROUND OF THE INVENTION

During renovation of wooden facades on older houses, it is normally required to remove several coats of successively painted unsightly cracked and flaking paint. Various methods are available for executing this work, wherein the removal of the paint for example can be carried out by means of scraping or grinding, which either implies a great effort of costly manpower or diffusion of ecologically harmful dust and disturbing noise. Previously, blow torches have also been utilized in order to burn off paint or rather to soften the paint by means of heating, so that it would be easier to scrape the paint off the wood. Caustic solutions or strong hydrocarbon-based solvents have also been utilized for removal of paint from wooden facades. All of these methods involve various disadvantages.

As a result of this, there has recently been a change to a method which implies that the paint is softened by radiation by means of a source of infra-red radiation. Thereafter, the paint is immediately removed by means of mechanical treatment of the wooden surface. Such a method and a device for execution of this method is described in U.S. Pat. No. 5,590,238. Apart from the radiation member, the device according to this patent also consists of a member for controlled vertical and horizontal moving of the carrier along the facade. This member for moving the carrier essentially consists of a horizontal rail which is intended to be fastened with screws in the base of the roof, in which rail a movable vertical bar is suspended and in turn supports the actual radiation device which is directed towards the wall. Thus, the radiation member can be moved horizontally by means of the fact that the suspended bar is moved in the horizontal rail, and vertically by means of the fact that it is screwed off and is moved upwards or downwards on the bar. Thus, in this manner, it is possible to reach a reasonably plane rectangular surface.

In WO 99/26798 another suspension device is described which discloses the use of a horizontally pivotable arm, one end portion of which is vertically displaceable and horizontally pivotally arranged on a bar which is adapted for vertical mounting on a wall or the like, and the other end portion of the arm supports one or several paint removal devices. The paint removal devices might for example be a heat radiator as described in U.S. Pat. No. 6,304,721.

### Technical Problem

Even though the suspension arm described in WO 99/26798 has certain benefits there is still a desire to improve the easiness in controlling and manoeuvring the paint removal device at the distal end of the suspension arm. The suspension arm in WO 99/26798 allows the paint removal devices to be moved in different directions but experiment and research have shown there is a need to improve the flexibility and be able to make certain movements and reach desired positions with less time consuming operations and adapting the suspension to different kinds of objects to be treated depending on, for example, the size and shape of the object and its surface.

### Solution

As a result of this, a novel suspension arm has been construed to meet the requirements of a more flexible and efficient suspension arm. This novel device comprises a horizontally pivotable suspension arm, one end portion of which is vertically displaceable and horizontally pivotally arranged on a bar which is adapted for vertical mounting on a wall or the like, and the other end portion of the arm supports one or several paint removal devices. The suspension arm is at one end connected to a bar or the like by the use of a holder. The bar may be mounted in contact with a wall, a ceiling, a floor or the like or might be a separate stand or ladder scaffolding.

As described herein, the bar, to which the suspension arm is attached, is extending in a vertical direction. It is obvious to the person-skilled in the art that the bar may extend in the horizontal direction or any direction in between. However, in the following description the bar has an extension in the vertical direction for the easiness of explaining the constructive details of the invention

According to a first embodiment of the invention the arm is adapted to be able to rotate at least two sections which forms a part of the suspension arm to be placed in an overlapping position. According to this embodiment, the arm might be provided with several sections which all of them may be pivotally connected to be positioned in an overlapping configuration.

According to a second embodiment of the invention, which might be, but not necessary must be, an additional feature to the first embodiment, it is possible to adjust the suspension arm in the vertical direction without the need of releasing the suspension arm from its position attached to the bar in order to reach more locations. This can be achieved by having a pivotal connection between at least two of the sections, forming a part of the arm, which is perpendicular to the pivotal connection described in the first embodiment.

According to a third embodiment of the invention, which might be, but not necessary must be, an additional feature to the first and/or second embodiment, the paint removal devices comprise a support stand which admits rotation of the paint removal devices round a first axis of the stand, the stand being rotably mounted to the distal end of the arm in a plane of rotation essentially perpendicular to the plane of rotation of the paint removal device round said first axle of the stand. In addition, there might be another pivotal connection, which connects the stand to the arm, which is perpendicular to the other two connections.

According to a fourth embodiment of the invention, which might be, but not necessary must be, an additional feature to the first and/or second and/or third embodiment, the end portion which is vertically displaceable and horizontally pivotally arranged on a bar (11) is attached to the bar by means of a holder in the form of a hollow element, said element having a side wall and being open at each end so as to form a pipe like element, said element further provided with a cut-out along the longitudinal direction of the side wall all the way from the first end to the second end. The shape of the pipe might be square formed.

According to the invention, the various links are suitably connected with each other by means of rivets, hinges and screws for adjustment of the friction between the contact surfaces of the links. In some cases it might be useful to use connections which are adapted to be locked in certain positions and by removing a locking pin or the like easily can be changed to another position. In these cases the connections may be provided with predefined holding positions so as to stepwise change the pivotal connections. However, in most cases it most suitable to use connections which do not need a locking arrangement but can be easily turned and kept in place by rather small friction forces.

Further advantages and features of the invention and the different embodiments will be described in detail in the following sections.

### A BRIEF DESCRIPTION OF THE DRAWINGS

The invention will be further described in the following with reference to the annexed drawings, in which

FIG. 1 is a view of the suspension arm with a paint removal device in a working position when the arm is attached to a vertical bar

FIG. 2 is a perspective view of the suspension arm when the rigid sections of the arm are folded in an overlapping position

FIG. 3 is a side view of the suspension arm with a first kind of holder for attaching the arm to the bar when the rigid sections of the arm are folded in an overlapping position

FIG. 4 is a view from above of the suspension arm with a first kind of holder for attaching the arm to the bar when the rigid sections of the arm are folded in an overlapping position

FIG. 5 is a side view of the suspension arm with a second kind of holder for attaching the arm to the bar when the rigid sections of the arm are folded in an overlapping position

FIG. 6 is a view from above of the suspension arm with a second kind of holder for attaching the arm to the bar when the rigid sections of the arm are folded in an overlapping position

FIG. 7 is a perspective view of a heat radiating paint removal device adapted to fit to the distal end of the suspension arm

FIG. 8 is a perspective view of a small support arm provided with a support stand to be connected to the heat radiating paint removal device

### PREFERRED EMBODIMENT

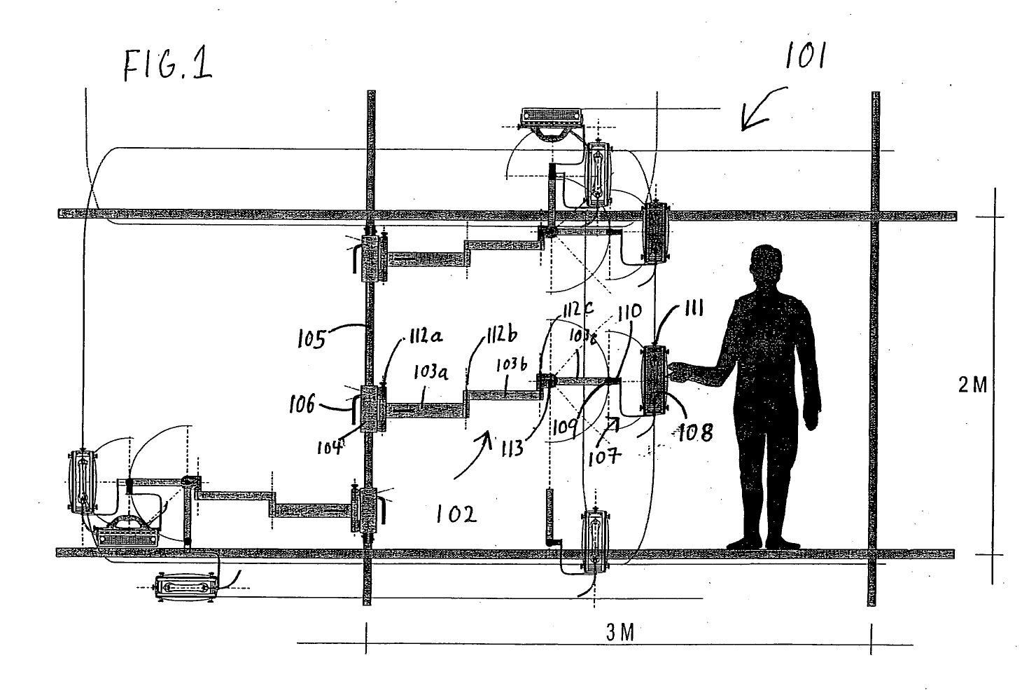

FIG. 1 shows a suspension device 101 according to the invention comprising an arm 102 which in the present case consists of three rigid sections 103 a, b, c. The arm can also consist of several links or of only two links. These rigid sections may consist of any suitable material such as aluminium, plastics, stainless steel or the like. The rigid section 103a is connected to a holder 104 which attaches the arm 102 to a bar 105. The holder 104 can be revolved around the bar 105 and can be moved upwards and downwards on the bar. However, the holder 104 is fixed in the vertical direction by means of a clamp actuated by the handle 106. By pulling the handle 106, the clamp will be released and the holder 104 and the arm 102 connected thereto may move along the bar 105. At the distal end of the arm 102, the outermost rigid section 103 c is attached to a stand 107 which supports a paint removal device 108. The stand 107 is pivotally mounted to the outermost rigid section 103 c by a hinge arrangement 109 around an horizontal axis perpendicular to the longitudinal direction of the arm 102 a. The stand 107 is further rotably mounted to the arm by a rotary connection 110 and being able to rotate freely round an axis parallel to the direction of extension of the arm as shown in FIG. 1.

The paint removal device 108 is rotably connected to the stand 107 by means of an axle 111 which is extending through the paint removal device 108 along the longitudinal axis of the paint removal device. Hence, the plane of rotation of these three pivotal connections are perpendicular to each other regardless of which position the stand 106 is positioned in and allows freedom to rotate the active element of the paint removal device 108 to a desired position in relation to the working surface, i.e. the surface to be treated by the paint removal device.

The rigid section 103 a is pivotally connected around a vertical axis to the holder 104 by means of a bolt 112 a which is adapted to be easily removed in order to disconnect the suspension arm 102 from the holder 104. The rigid sections 103 a, b and 103 b, c respectively are also pivotally connected by bolts 112 b, c. In addition, the rigid sections 103 b, c are pivotally connected by a hinge arrangement 113 around a horizontal axis perpendicular to the longitudinal direction of the arm 102 a.

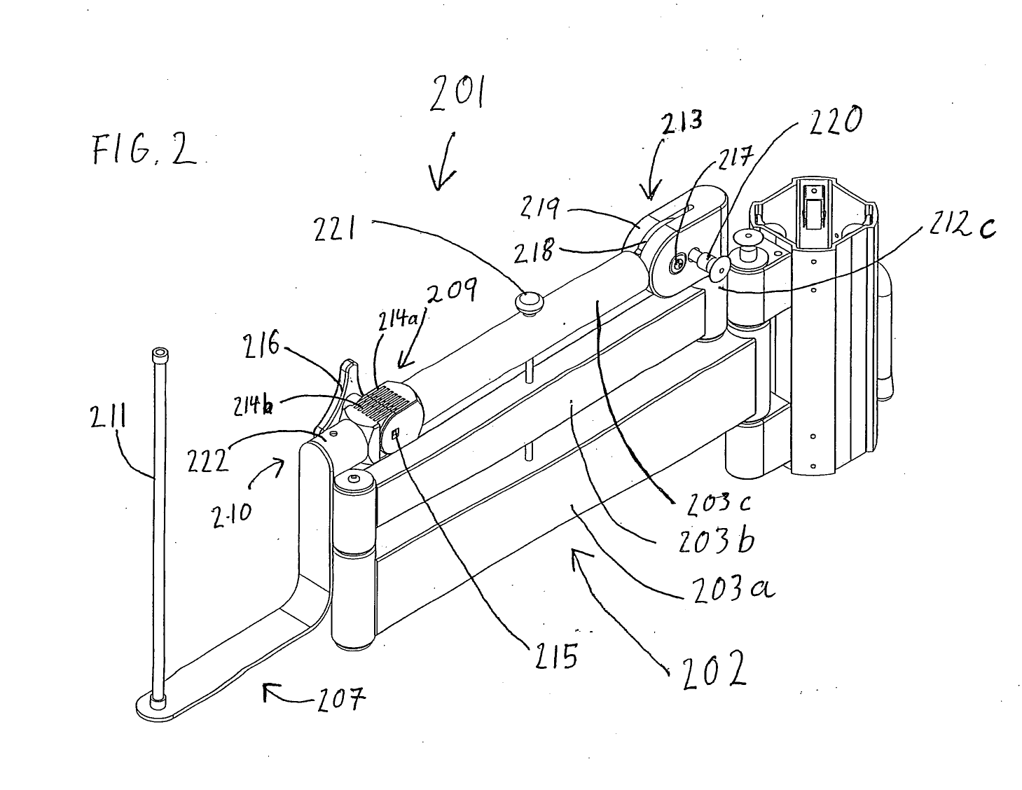

In FIG. 2 the features of the arm shown in FIG. 1 is shown in detail. In this figure, the axle 211 by which the paint removal device (not shown) is connected to the stand 207 is clearly shown. The hinge arrangement 209 between the stand 207 and the rigid section 203a is also shown. The hinge arrangement comprises a number of lamellas 214 a, b or thin plates of which the lamellas 214a are secured to the rigid section 203 c and the lamellas 214 b are secured to the stand 207. These lamellas are provided with a hole 215 and are spaced apart so that the lamellas 214 of the rigid section 203 a and the stand 207 fits close with each other and forms through going hole 215 when the suspension device 201 is mounted. A bolt 216 is fitted in the hole 215 and the easiness of turning the hinge arrangement 209 can be adjusted by tightening or unscrewing the bolt 216 in order to fix the stand 207 at a desired position or to make turning of the connection easy. The other hinge arrangement 213 is made by the use of a bolt 217 forming the centre of rotation by penetrating a disc 218 connected to the rigid section 203 a which is squeezed between a clamp 219 connected to the bolt 212 c. This hinge arrangement is further provided with a locking pin 120 which easily can be pulled out in order to release the locking and allow the hinge arrangement 213 to easily turn. The locking pin may thereafter be inserted again in order to lock the hinge arrangement in a desired position. In a preferred embodiment the hinge arrangement 213 is adapted to be locked in a number of predefined positions so as to stepwise regulate the elevation angle between the rigid sections 203 b, c. In this figure, it is also shown how the suspension arm 202 can be locked in a transport configuration by using a locking bolt 221. The rigid sections 203 a, b, c are provided with holes which, when the rigid sections are positioned in an overlapping configuration, are adapted to be aligned so that the locking bolt 221 may fit into the holes and lock the suspension arm 202 in a folded configuration.

The rotary connection 210 between the stand 207 and the distal rigid section 203 c is formed by a short round, hollow pipe section 222 attached to the stand 207 which is fitted onto a round rod attached to the lamellas 214 a which forms a part of the hinge arrangement 209.

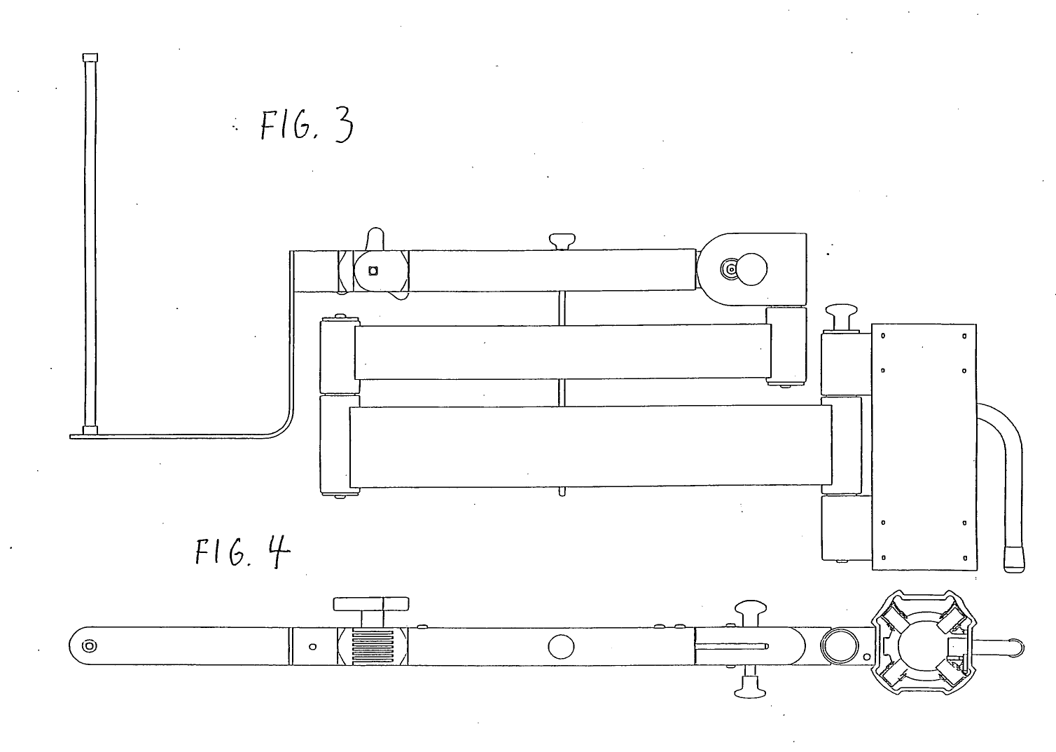

FIGS. 3 and 4 is a side view respectively a view from above of the suspension device 201 shown in FIG. 2. These figures shows essentially the same features as already have been showed in the earlier figures but are enclosed in order to present a more complete image of the suspension device.

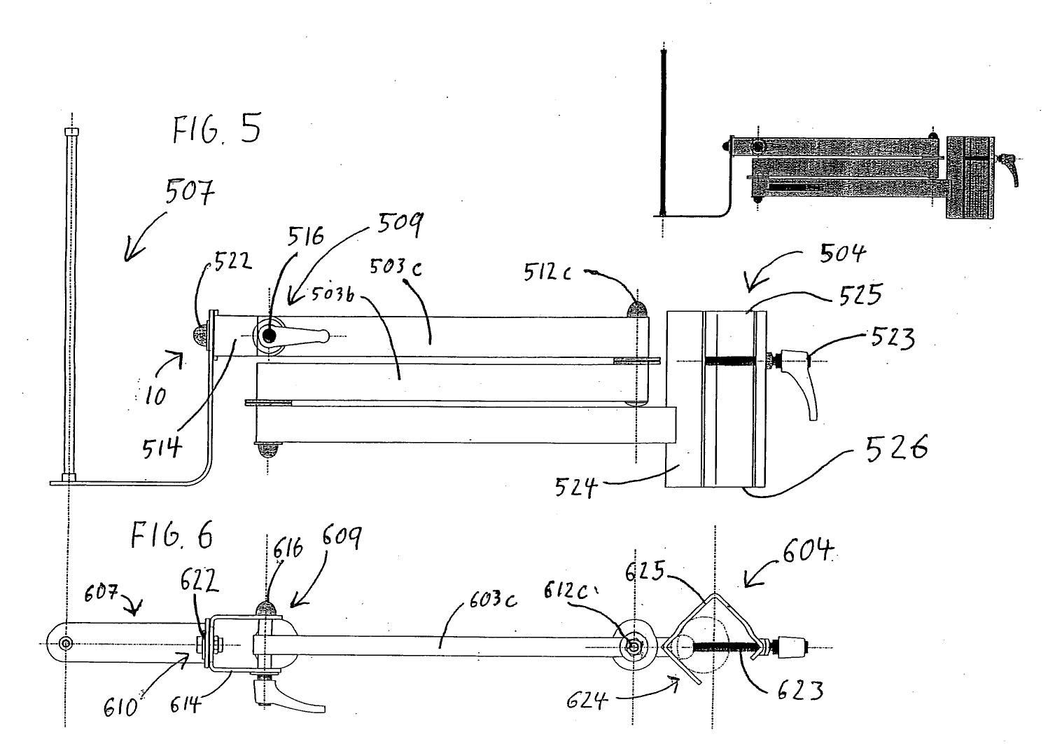

In FIG. 5, a modified suspension arm is shown. When compared with the arm shown in FIGS. 1-4, there is no hinge connection associated with the bolt 512 c. Hence, the connection between the rigid sections 203 b and 203 c is only adapted to be able to rotate horizontally around the vertical bolt 512 c.

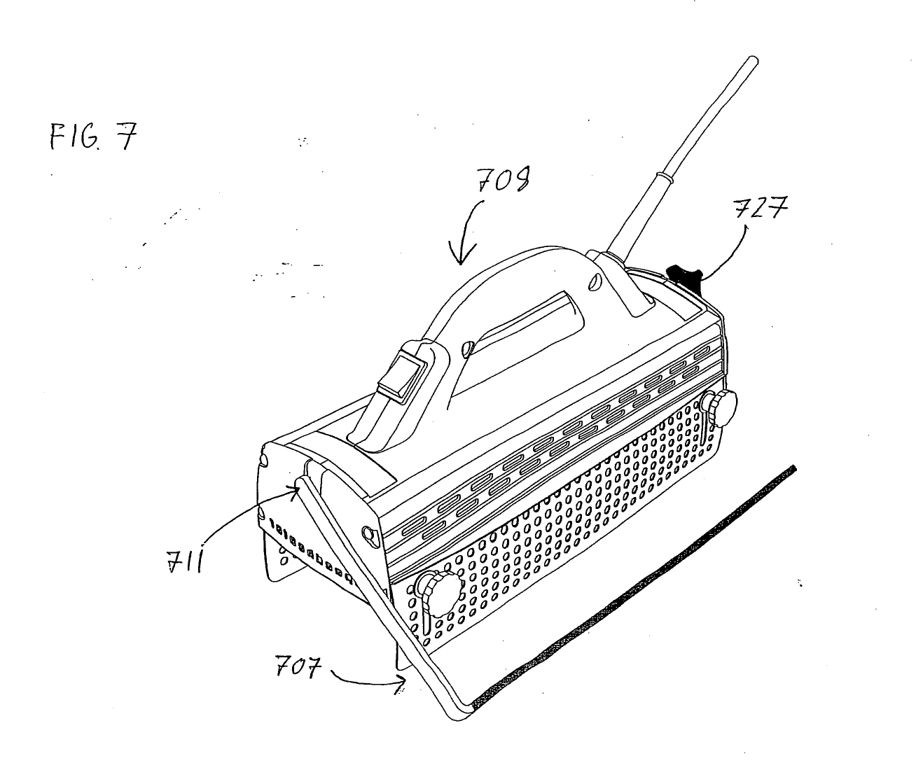

In FIG. 6, a view from above of the suspension device shown in FIG. 5 is shown. From this view, some further differences can be more clearly seen. The connection between the rigid section 603 c and the stand 607 differs in that the hinge arrangement 609 is made by a clamp 614 which is secured to the stand 607 and squeezes the distal end of the rigid section 603 c. The clamp 614 and the distal end of the rigid section 603 c are provided with holes 615 through which a bolt 616 can be fitted and the turning of the hinge arrangement can be adjusted by unscrewing the bolt 616 to easily turning the connection 609 or tightened to fix the connection 609 in a desired position. Also the rotary connection 610 is different constructed and a bolt 622 is used to rotably connect the stand 607 to the clamp 614. However, the functionality of the connection between the stand 607 and the distal rigid section 603 c is the same in the suspension device shown in FIG. 1-4 as it is in the device described in FIGS. 5 and 6.

Again referring to FIGS. 5 and 6, there is a further difference between this suspension device and the one shown in FIG. 1-4. In this modified suspension device, the holder 504, 604 has the shape of an essentially square formed pipe section provided with a screw bolt 523, 623 from which a part of the wall 524, 624 of the pipe section forming the holder 504, 604 has been cut out completely. This has the effect that the holder 504, 604 easily can be removed from a bar (see 105 in FIG. 1) without the need of threading the holder all the way up to the end of the bar in order to remove the holder 504, 604 from the bar. This is particularly advantageous when the holder is positioned on bar which not allow free movement along the bar to a desired position due to any kind or obstacles, e.g. a ladder scaffolding which comprises transversal bars connected to the vertical bars which makes it impossible to thread a holder onto the desired sections of the vertical bar.

The screw bolt 523, 623 might be positioned at different location on the holder 504, 604 but is preferably positioned in the upper part of the holder, near the upper edge 525 of the holder, when the holder is mounted on a vertical bar. Such an arrangement will increase the frictional forces working between the lower part of the holder 504, 604 and the bar due to a longer lever arm, which is formed by the distance between the vertical distance between the position of the screw bolt 523, 623 and the lower edge 526 of the holder 504, 604. The screw bolt is preferably placed at a distance of at least ⅔ of the whole distance from the lower edge 526 and even more preferably at a distance of at least ¾ from the lower edge 526.

Even though the holder 504, 604 is clamped against a bar by the use of the screw bolt 523, 623, the holder can be easily rotated round an ordinary round bar. The frictional resistance is mainly working in the vertical direction and the resistance for rotating the holder 504, 604 round the bar is quite low even if the screw bolt 523, 623 is tightened quite hard.

The shape of the holder and the positioning of the bolt shows an preferred embodiment but this inventive concept will work for other geometries of the holder 504, 604 such as round, oval, hexagonal, triangular or other shapes of the wall 524, 624 forming the pipe segment.

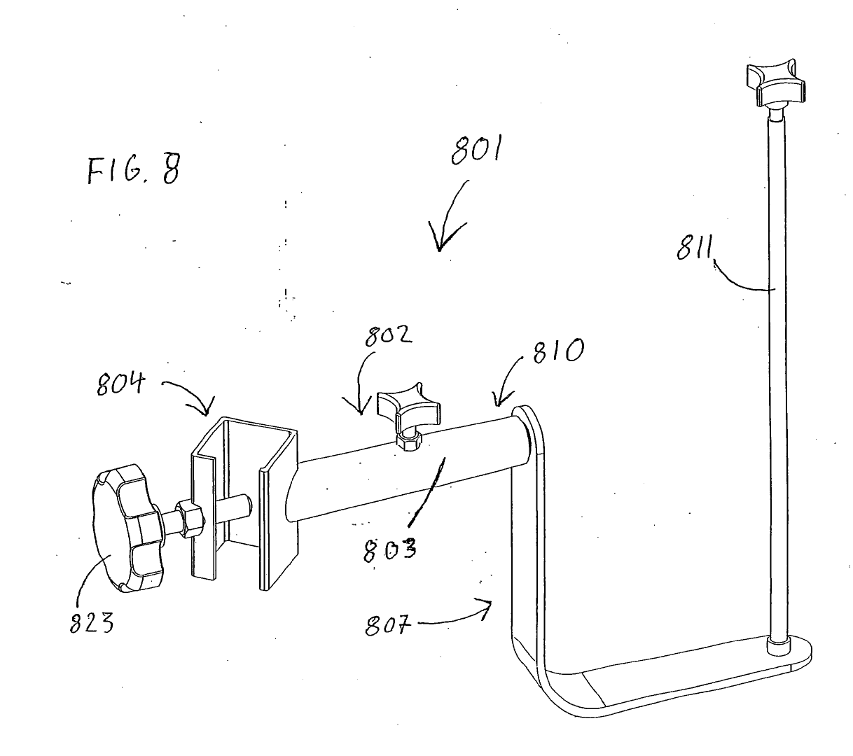

In FIG. 7, a paint removal device 708 is shown which is attached to a stand 707. The axle 711 is threaded through the paint removal device 708 along its longitudinal axis and secured at the distal end by a screw head 727. The paint removal device 708 may thus freely rotate around the axle 711 and is prevented from axial movement along the axle 711 by the screw head 727.

In FIG. 8, still another modified suspension device 801 is shown. The holder 804 is basically of the same type as is shown in FIGS. 5 and 6. The stand 807 is also basically the same as described before, comprising an axle 811 to rotably connect a paint removal device but its connection to the suspension arm 802 is only provided with a rotary connection 810. In this case, when there is no pivotal connection in the suspension arm 802 itself and the arm only comprises on single rigid section 803 the rotational connections of the holder 804 to the bar and the paint removal device (not shown) to the axle 811 of the stand 807 represents free rotation in a first rotational direction having a vertical axis and the rotation of the suspension arm 802 to the stand 807 represent a rotational direction being perpendicular to the first rotational direction having an axis of rotation parallel with the longitudinal extension of the suspension arm 802. The vertical adjustment can be made by unscrewing the screw bolt 823 and move the holder 804 along the bar.

1. Suspension device for a paint, varnish or putty removal devices, said removal devices are intended to be arranged near or in contact with a wall, a ceiling, a floor or the like, and which are adapted for treatment of old paint, putty or varnish on the surface of an object by means of heat radiation, said suspension device comprises a horizontally pivotable arm which at one end portion is displaceable mounted and horizontally pivotally arranged on a bar and the other end portion of the arm supports one or several paint removal devices which is rotably connected to the arm, said arm comprising at least a first and a second rigid section being horizontally pivotally connected to each other round a vertical axis.

2. Suspension device according to claim 1 in which said at least two rigid sections being arranged to be able to rotate to be positioned in an overlapping position

3. Suspension device according to claim 2 in which the at least two rigid sections are pivotally connected so that the first section may freely rotate 360 degrees horizontally around the axle connecting said two rigid sections.

4. Suspension device according to claim 2 in which the suspension device comprises a third rigid section being arranged to be able to rotate horizontally to be positioned in an overlapping position together with the first two rigid sections.

5. Suspension device according to claim 1 in which at least one rigid section at one end being vertically pivotally connected to the bar or another rigid section of the suspension arm.

6. Suspension device according to claim 1 in which a first rigid section at one end being connected to the one or several paint and/or varnish removing devices and at its other end being vertically pivotally connected to a second rigid section

7. Suspension device according to claim 6 in which the vertically pivotally connection between the first and second rigid sections is provided with predefined steps in order to position the second rigid section at different predefined angles relative to the horizontal plane.

8. suspension device according to claim 7 in which the at least two rigid sections are pivotally connected so that the first section may freely rotate 360 degrees horizontally around the axle connecting said two rigid sections and vertically rotate 180 degrees from a position where the second rigid section is pointing upward to a position where the second rigid section is pointing downward.

9. Suspension device according to claim 1 in which said one or several paint removal devices comprise a stand which admits rotation of the one or several paint removal devices round an axle forming first axis of the stand, the stand being rotably mounted to the arm in a plane of rotation essentially perpendicular to the plane of rotation of the paint removal device round said first axis of the stand.

10. Suspension device according to claim 9 in which said stand is pivotally mounted to the arm in a plane of pivotal movement essentially perpendicular to the plane of rotation of the paint removal device round said first axis of the stand and the plane of rotation of the stand round the arm.

11. Suspension device according to claim 10 in which said stand comprises a first axle which is adapted to be connected to at least one paint removal device so as to form said first axis of rotation of the stand, said axle, at or near one of its ends, being connected to a first rod pointing out essentially perpendicular to the longitudinal direction of the first axle, said rod being connected to a second rod essentially extending in a direction parallel to said first rod, said second rod being rotably mounted to the arm and when rotated forming a plane of rotation parallel to the longitudinal extension of the third rod, said third rod being rotably mounted to the arm at or near the location of centre of gravity of the paint removal devices and the stand in the plane of rotation of the stand.

12. Suspension device according to claim 1 in which said one end portion which is vertically displaceable and horizontally pivotally arranged on a bar (11) is attached to the bar by means of a holder in the form of a hollow element, said element having a side wall and being open at each end so as to form a pipe like element, said element further provided with a cut-out along the longitudinal direction of the side wall all the way from the first end to the second end.

13. Suspension device according to claim 12 in which said holder is further provided with a screw adapted to protrude through the side wall of the holder and by screwing it inwards effectuating a clamping force between the side wall of the holder and the bar so as to fix the holder in a vertically fixed position.

14. Suspension device according to claim 12 in which said holder has a rectangular shape.

15. Suspension device for a paint, varnish or putty removal devices, said removal devices are intended to be arranged near or in contact with a wall, a ceiling, a floor or the like, and which are adapted for treatment of old paint, putty or varnish on the surface of an object by means of heat radiation, said suspension device comprises a horizontally pivotable arm which at one end portion is displaceable mounted and horizontally pivotally arranged on a bar and the other end portion of the arm supports one or several paint removal devices which is rotably connected to the arm, said arm comprising a rigid section connected at one end to a holder adapted to be arranged on a bar and at its other end connected to a paint removal device via a stand, said stand being rotably connected to the bar and further comprises an axle to which the paint removal can be threaded on in order to rotably arrange the paint removal device so as to rotate in a rotational direction perpendicular to the rotational direction of the connection between the arm and the stand.

16. Suspension device according to claim 3 in which the suspension device comprises a third rigid section being arranged to be able to rotate horizontally to be positioned in an overlapping position together with the first two rigid sections.

17. Suspension device according to claim 2 in which at least one rigid section at one end being vertically pivotally connected to the bar or another rigid section of the suspension arm.

18. Suspension device according to claim 3 in which at least one rigid section at one end being vertically pivotally connected to the bar or another rigid section of the suspension arm.

19. Suspension device according to claim 4 in which at least one rigid section at one end being vertically pivotally connected to the bar or another rigid section of the suspension arm.

20. Suspension device according to claim 2 in which a first rigid section at one end being connected to the one or several paint and/or varnish removing devices and at its other end being vertically pivotally connected to a second rigid section
